(19) United States
(12) Patent Application Publication
(10) Pub. No.: US 2020/0286192 A1
(43) Pub. Date: Sep. 10, 2020

(54) BUFFERED ORDER MANAGEMENT SYSTEM WITH COMPUTER VISION CHECKS FOR AUTOMATED RESTAURANT ORDER ASSEMBLY

(71) Applicant: SHAMBHU NATH ROY, Roseville, CA (US)

(72) Inventors: Shambhu Nath Roy, Roseville, CA (US); Manish Patel, El Dorado Hills, CA (US); Joseph Felipe, Roseville, CA (US)

(21) Appl. No.: 16/291,533

(22) Filed: Mar. 4, 2019

(51) Int. Cl. G06Q 50/12; G06Q 30/06; B25J 11/00; B25J 9/16

(52) U.S. Cl. CPC G06Q 50/12; B25J 9/1697; B25J 11/008; G06Q 30/0635

(57) ABSTRACT

A buffered order management system that allows restaurant employees and robots to operate together without the need for waiting for each other or getting in each other's way with the use of input and output tray buffers. Vision based checks are used to detect manual loading errors to prevent disruptions in robot operation while reducing need for employees to watch over the robot performing tasks continually. Weighing stations are used to detect presence and check weights of items plated into meal tray assemblies ensuring that they are within control limit quantities as per order recipes. Intermediate buffers are used when multiple stations are needed with automated and manual meal assembly tasks to allow robots and employees to work loosely coordinated reducing employee stress but higher efficiency of robots and high productivity for the entire restaurant.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention generally relates to managing multiple orders using automated meal assemblers or robots to service restaurant customers allowing restaurant employees to work efficiently reducing the need to closely coordinate with such automated systems or co-bots as they are known in the art while allowing both employees and automated systems to work together without disrupting each other's flow with less stress for employees.

Robots can work well on their own with consistent cycle times as long as the inputs including instructions for a task to be completed or commands, data and raw materials or work pieces needed are timely provided such as trays and containers for meals and food items, ingredients as well as the output such as assembled meal orders are continuously removed from receiving spots for completed orders. Usually in a restaurant environment human operators are responsible to feed the inputs to the robots and remove the output assembled meal orders timely and in a continuous way. However since human operators cannot often work with same speed and dedication as the robot there is often a mismatch which causes disruptions, holding the restaurant customer orders and lines. Further if employees have to continuously stay engaged and watch with their robot partner or co-bot it reduces the productivity of both the robots and employees.

Further a robot expects everything to be perfect as specified in its design, such as location of an input order assembly tray; any aberrations such as a missing container in an order assembly tray, input order assembly tray at a loading position when expected to be there, a wrongly located input order assembly tray, an improperly entered location or order information will cause severe malfunction such as plating of food items without a container on an order assembly tray or dropping a tray by the robot not being able to pick it up, trying to place a tray double parked when the last tray has not been removed in time or wrongly input state by their human counterpart as tray location was cleared but actually present. All of these can cause the line to go down causing loss in restaurant revenue as well as damage to the robot and other losses.

A need therefore exists for a restaurant order management system that can allow efficient use and easy cooperation between human employees and automation to allow each to work at their own pace without waiting on each other or coming in way of each other.

### BRIEF SUMMARY OF THE INVENTION

The present invention provides a buffered order management system that allows restaurant employees and robots or other automated machines to operate together seamlessly and efficiently without the need for waiting for each other or getting into conflicts for successfully preparing multiple meal orders in a restaurant environment.

An object of the invention is to provide a input tray buffer interface between a restaurant order assembly robot or other automated systems and a human operator that can accommodate a large number of order assembly trays such that the automated systems can continuously run without having to wait for new order assembly trays. Having a pool of input order assembly trays allows the robot to keep working at its steady speed and also allows an employee to replenish the input tray buffer stack when the number falls below a certain comfort level as monitored by the tray buffer management system in association with a computer software or other electronic management systems as known in the art. Having an opportunity to load a larger number of order assembly trays at one time also frees up additional time for the employees to conduct other more important activities helping to improve the function of the restaurant instead of feeding individual order assembly trays for each individual orders while the robot consumes the stack of input order assembly trays.

A further object of the invention is to provide an output tray buffer stack interface between a restaurant food assembly robot or other automated systems and a human operator that can accommodate a large number or completed order assembly trays such that the automated system can continuously run without having to wait for new open spots for depositing each completed order. Having a larger number of completed order positions in an output tray buffer also frees up time for the employee to conduct other more important activities helping to improve the function of the restaurant instead of clearing individual completed meal orders for every meal assembled continuously.

A further object of the invention is to provide intermediate tray buffer stacks where multiple automated systems and human tasks are used to assemble orders to allow loose coupling or coordination needs between such automated systems and human tasks in the restaurant order assembly lines.

Yet another object of the invention is to incorporate computer based vision checks to detect human errors such as loading an input order assembly tray improperly in the input buffer stack, missing a container or cup in order assembly trays, placing an unknown tray type or not having cleared an output receiving location but notifying the robot otherwise or vice versa. According to an embodiment of the invention artificial intelligence is used to train the order management system based on training data to detect these errors.

A further object of the invention is to use weighing stations to check that the robot has plated the recommended food item quantities in the order assembly trays as needed without the need for an employee to observe or check each and every assembled order for completeness or errors.

A further object of the invention is to provide an additional camera to observe the meals being assembled and monitoring errors in order assembly trays in the line.

According to an embodiment of the invention, the cameras are also used to provide remote supervision capability by the restaurant employees or customers by connecting the camera feed to a monitor or via remote access. Customers can watch their online orders being plated remotely on a computer or a hand held device.

According to an embodiment of the invention, the cameras are also used to provide remote correction capability by the restaurant employees by allowing remote manual operation of robots.

Additional features and advantages of the present invention are described in, and will be apparent from, the detailed description of the preferred embodiments and from the drawings.

### BRIEF DESCRIPTION OF THE SEVERAL VIEWS OF THE DRAWING

The following is a description, by way of example only, of different embodiments of the mechanism, its variations, derivations and reductions.

FIG. 1 shows a buffered order management system with a frame and a robot working on a salad bench.

FIG. 2 shows an alternate view of buffered order management system.

FIG. 3 shows a buffered order management system without the frame and salad bench in FIGS. 1 and 2 as well as the weighing stations exposed with a partially exploded view.

FIG. 4 shows detailed views of an input tray buffer and an order assembly tray.

FIG. 5 shows a view of the input tray buffer stack as seen by the input buffer monitoring camera.

FIG. 6 shows an outline of a correctly put together order assembly tray and properly loaded onto input tray buffer stack, as extracted by a computer vision from the image from the input buffer monitoring camera.

FIG. 7 shows another view of the input tray buffer stack as seen by the input buffer monitoring camera with several erroneously placed order assembly trays and the corresponding outlines extracted by a computer vision system to detect such.

FIG. 8 shows order assembly trays moving on an assembly line tray track as seen by a tray track monitoring camera.

FIG. 9 shows an improperly orientated order assembly tray as detected by a computer vision system using a tray track monitoring camera.

FIG. 10 shows a restaurant line with an intermediate tray stack buffer between two automated assembly stations.

### DETAILED DESCRIPTION OF THE INVENTION

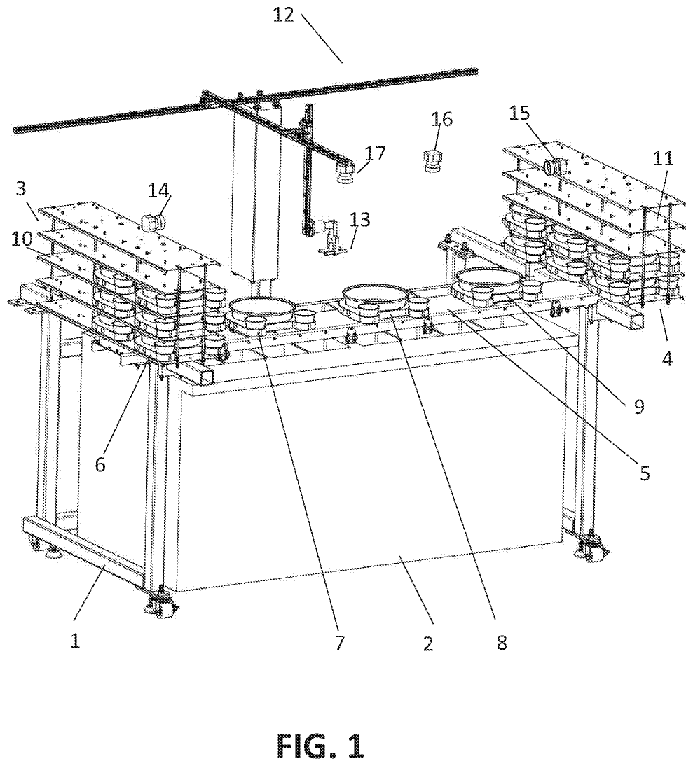

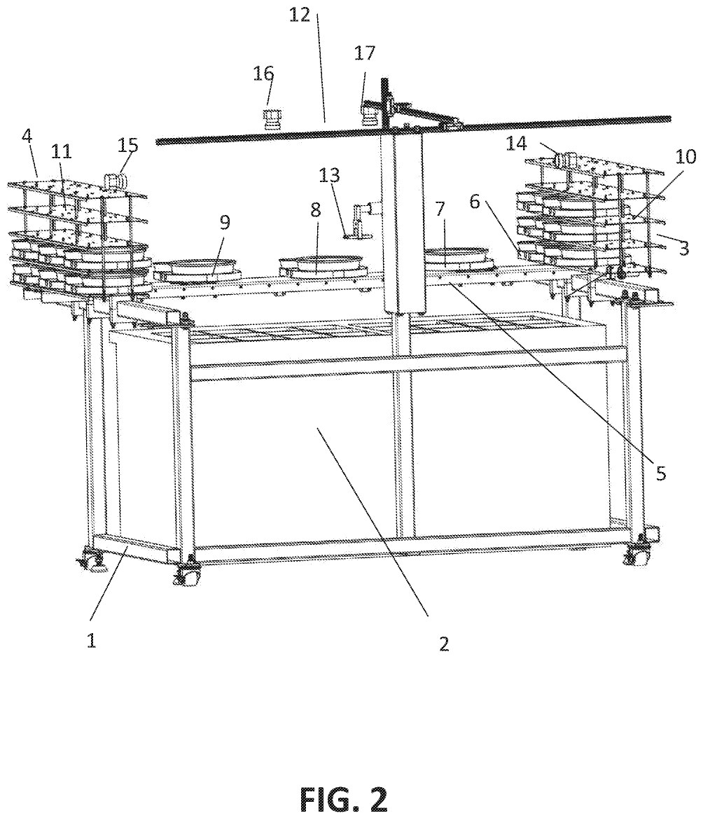

Now referring to the drawings, wherein like numerals designate like components, FIGS. 1 and 2 show a buffered order management system where an input tray buffer stack 3 and an output tray buffer stack 4 are fixed on a frame 1 placed on either side of an order assembly tray track 5. Input tray buffer stack comprises of a plurality of input order assembly tray loading locations formed using shelf members 10 on input tray buffer stack 3 and output tray stack comprises of a plurality of output tray receiving locations formed using shelf members 11 on output tray buffer stack 4. Order assembly trays 6, 7, 8, 9 cycle through the buffered order management system in various stages starting from input order buffer stack and moving through assembly locations with a final destination as one of open output order locations on output tray buffer stack 4.

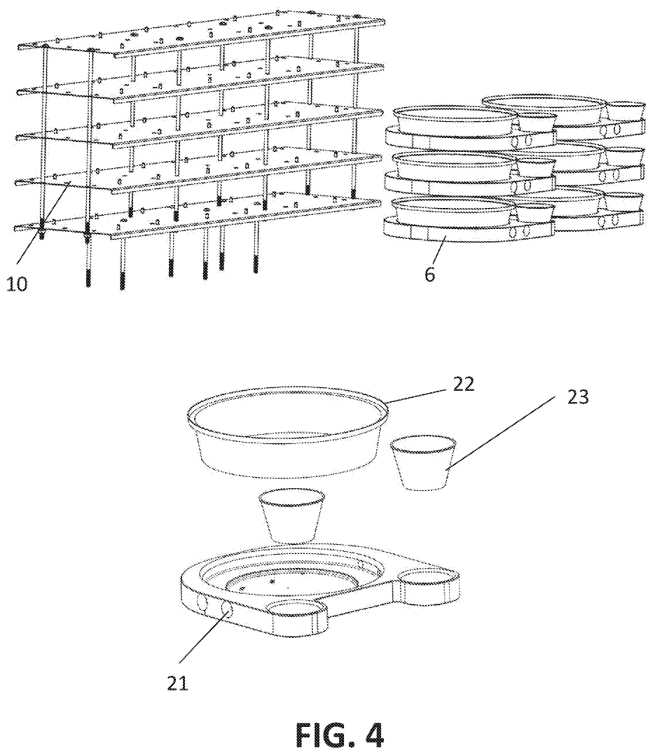

Still referring to FIGS. 1 and 2, the order assembly trays 6, 7, 8, 9 are moved by a multi-axis robot 12 through the buffered order management system utilizing an end effector 13 picking the order assembly trays with suitable picking means. More specifically the multi-axis robot is able to pick the order assembly tray from the input order stack 3 and place on the order tray track 5. Food items as per recipe are picked from a source such as a sandwich prep bench 2 and plated into the receiving containers 22 and 23 present in an order assembly tray as shown in detail in an exploded view in FIG. 4 and is comprised of a tray base 21 with side holes as a means to be picked up by robot end effector 13, holds the receiving main dish container 22 and additional side order dish containers 23. For example when making a chicken salad, the customer may want dressings on the side to be added later when they consume. The multi-axis robot is able to move the order assembly trays forward on the order tray track 5 and then place them on to an open position on the output order stack 4.

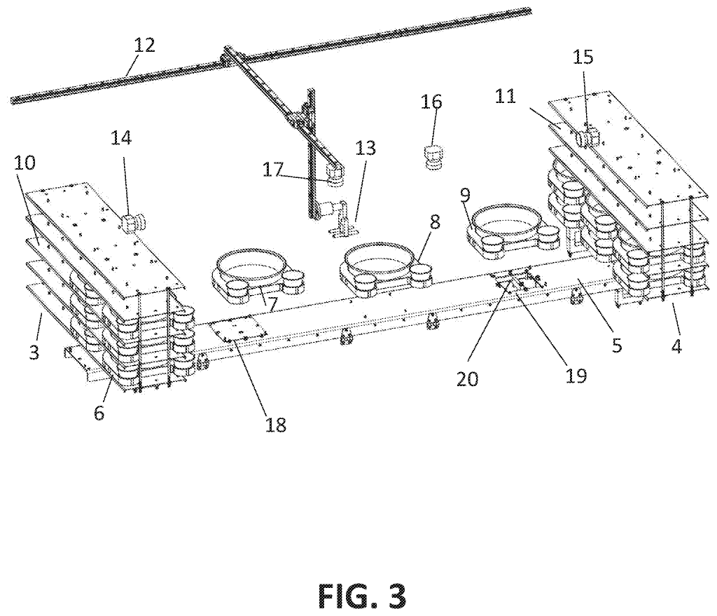

Further as can be seen in FIG. 1, 2 and a partially exploded view shown in FIG. 3, an input buffer monitoring camera 15 is suitably placed so as to be able to observe and capture images of the order assembly tray positions and loaded order assembly trays for computer vision image processing. An output buffer monitoring camera 14 is suitably placed so as to be able to observe and capture images of the open order assembly tray positions and loaded order assembly trays for computer vision image processing. Further an order tray track monitoring camera 16 is suitably placed so as to observe and capture images of order assembly trays and their contents as they progress on the tray track 5. An additional order tray track monitoring camera 17 is attached to multi-axis robot 12 so as to observe and capture images of order assembly trays and their contents as they progress on the tray track 5. The tray track 5 also comprises of weighing stations 18 and 19 that allow to measure the weights of the order assembly trays as food items are plated to track the quantity of food items are within allowable control as per the order description. This frees up the restaurant employees from the task of supervising if the orders are being plated correctly into containers and in right amounts. As seen in FIGS. 1 and 2 the order assembly trays 7 and 9 are at plating stations 18 and 19 whereas 8 is at an intermediate resting station. The plating is done only at the plating stations which are capable of dynamically monitoring the total current weight utilizing load cell 20 as shown in FIG. 3 with the top of the plating station removed revealing the load cell 20. Each food item weight is computed by taking the different in the total weight measured before and after each item is plated. When the plating is done only at the plating stations the load cells are also used as order assembly tray present sensors and ensuring that a tray is always present before plating food items.

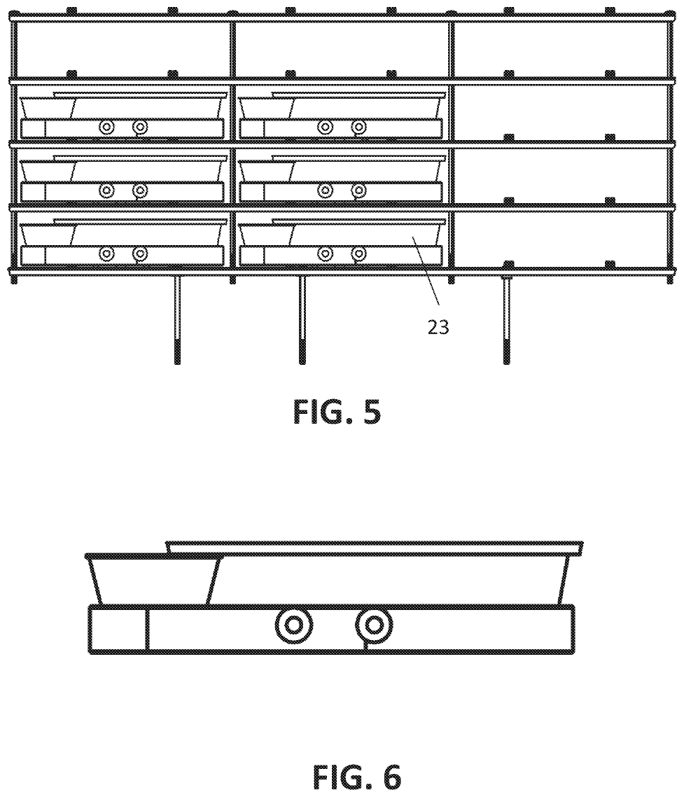

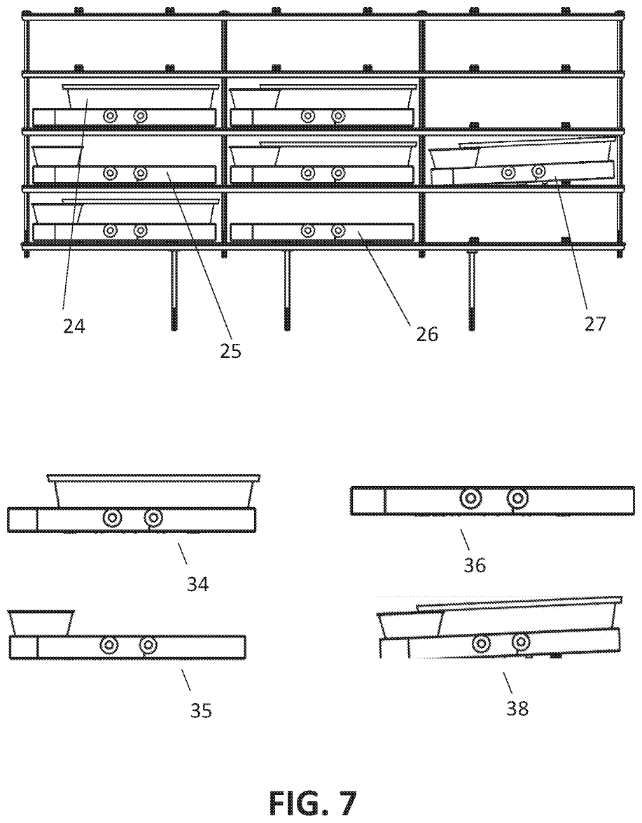

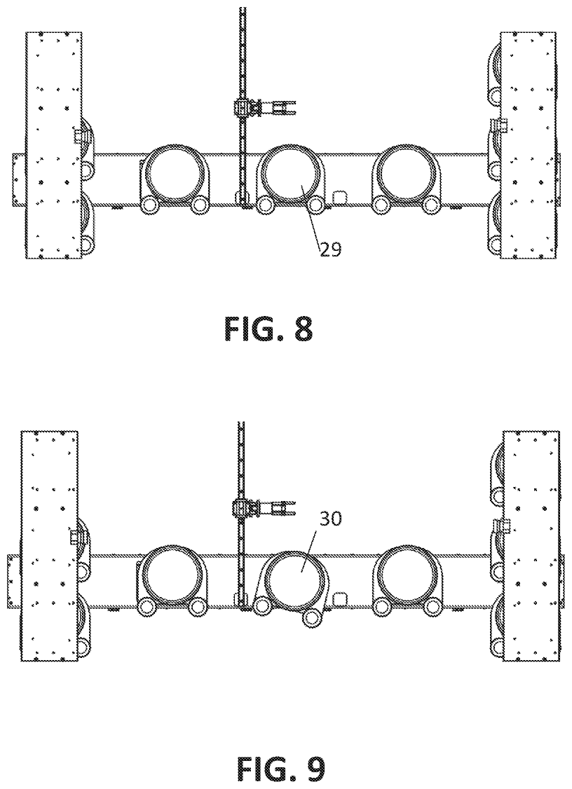

FIG. 5 shows the view of the input tray buffer stack 3 as seen by input buffer monitoring camera 15. Using image processing an outline is extracted from every input meal assembly tray receiving location on the input tray buffer stack 3. FIG. 6 shows one such outline of an order assembly tray 28 in FIG. 5 is present along with containers as explained earlier and shown in FIG. 4. The complete lack of meal order assembly tray outline is used to conclude an open position. Further as can be seen in FIG. 7 various possible outlines can be used to identify errors such as a missing side dish container for tray assembly 24 producing an outline 34, a missing main dish container for tray assembly 25 producing an outline 35, missing both containers as in tray assembly 26 producing an outline 36 and a misplaced order assembly tray 27 producing an outline 37. The order management system is able to use these cases to train an artificial intelligence based algorithm to identify other similar operation errors in loading and generate alarms. Some of the errors such as a mis aligned order assembly tray can be corrected by the multi-axis robot 12 shown in FIG. 1, for others such as missing containers the order management system notifies the employees to correct those while it is using the correctly loaded trays without any slowing down of the line. Further as seen in FIG. 8 and FIG. 9 the images from tray track monitoring camera 16 is used to detect errors such as a mis-oriented order assembly tray 30 by comparing with standard or known good historical data with a good position tray 29.

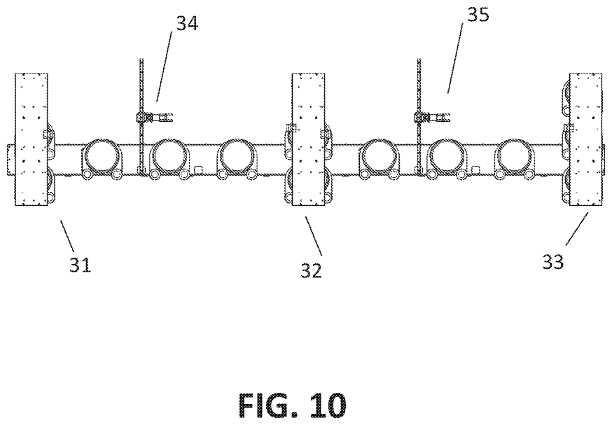

Now referring to FIG. 10, a top view of an order management system is seen with two robots 34 and 35 working together to plate orders received at input buffer tray stack 31 and depositing completed orders at output buffer tray stack 33. Since the robots 34 and 35 may not always be able to work in perfect coordination an intermediate tray buffer stack 32 is used to allow them to work more loosely coordinated by providing additional intermediate meal order storage locations. Instead of a second robot or automated station 35 it could also be a manual task station.

All though the invention has been described herein in connection with various preferred embodiments, there is no intention to limit the invention to those embodiments. It should be understood that various changes and modifications to the preferred embodiments will be apparent to those skilled in the art. Such changes and modifications may be made without departing from the spirit and scope of the present invention and without diminishing its attendant advantages. Therefore, the appended claims are intended to cover such changes and modifications.

What is claimed is:

1. A buffered order management system comprising:
A plurality of order assembly trays;
an input tray buffer with a plurality of loading positions for receiving said order assembly trays;
an output tray buffer with a plurality of receiving positions for depositing said order assembly trays;
at least one tray track with at least one order assembly position for plating food items in said order assembly trays;
at least one robot with an end effector;
wherein, said robot is capable of transporting said order assembly trays between said loading positions, said assembly positions and said receiving positions.

2. A buffered order management system as in claim 1, further comprising:
at least one input buffer camera for observing said order assembly trays on said input tray buffer;
at least one output buffer camera for observing said order assembly trays on said output tray buffer.

3. A buffered order management system as in claim 1, further comprising:
at least one tray track camera for observing said order assembly trays on said tray track.

4. A buffered order management system as in claim 1, further comprising:
at least one order assembly position with a weighing station.

5. A buffered order management system as in claim 4:
wherein said weighing station is also used as said order assembly tray present sensor.

6. A buffered order management system as in claim 4:
wherein, said weighing station is a load cell and dynamically measures weight changes to calculate weights of each food items as they are plated by computing the difference before and after as each item is plated.

7. A buffered order management system as in claim 2:
wherein, images from said input buffer camera is used to detect open or loaded said receiving positions on said input tray buffer;
wherein, images from said output buffer camera is used to detect open or occupied said depositing positions on said output tray buffer.

8. A buffered order management system as in claim 2:
wherein, images from said input tray buffer camera are used for detecting manual loading errors.

9. A buffered order management system as in claim 1:
wherein, said order assembly trays comprise of a main container for assembling a main dish and at least one container for a side order.

10. A buffered order management system as in claim 1:
wherein, said input tray buffer is made of a plurality of input shelfs stacked vertically;
wherein, said output tray buffer is made of a plurality of output shelfs stacked vertically.

11. A buffered order management system as in claim 8:
wherein, said robot is used to correct said manual loading errors by allowing remote manual operation of said robot.

12. A buffered order management system as in claim 8:
wherein, artificial intelligence algorithms are used to train said buffered order management system to train and detect said manual loading errors.

13. A buffered order management system as in claim 3:
wherein, said tray track monitoring camera is used to provide remote supervision capability.

14. A buffered order management system as in claim 3:
wherein, said tray track monitoring camera is used to allow customers to watch their online orders being plated.

15. A buffered order management system comprising:
A plurality of order assembly trays;
an input tray buffer with a plurality of loading positions for receiving said order assembly trays;
an output tray buffer with a plurality receiving positions for depositing said order assembly trays;
at least one tray track with at least one order assembly position for plating food items in said order assembly trays;
an intermediate tray buffer with a plurality of receiving positions for depositing said order assembly trays;
at least one robot with an end effector;
wherein, said robot is capable of transporting said order assembly trays between said loading positions, said assembly positions and said receiving positions.

16. A buffered order management system as in claim 15, further comprising:
at least one input buffer camera for observing said order assembly trays on said input tray buffer;
at least one output buffer camera for observing said order assembly trays on said output tray buffer;
wherein, images from said input buffer camera is used to detect open or loaded said receiving positions on said input tray buffer;
wherein, images from said output buffer camera is used to detect open or occupied said depositing positions on said output tray buffer.

17. A buffered order management system as in claim 15, further comprising:
at least one tray track camera for observing said order assembly trays on said tray track.

18. A buffered order management system as in claim 15, further comprising:
at least one order assembly position with a weighing station.

19. A buffered order management system as in claim 18:
wherein, said weighing station is also used as a tray presence sensor.

20. A buffered order management system as in claim 18:
wherein, said weighing station is a load cell and dynamically measures weight changes to calculate weights of individual food items as they are plated by computing the difference before and after as each item is plated.
